(19) United States
(12) Patent Application Publication
(10) Pub. No.: US 2015/0296302 A1
(43) Pub. Date: Oct. 15, 2015

(54) LOUDSPEAKER WITH COMPLIANTLY COUPLED LOW-FREQUENCY AND HIGH-FREQUENCY SECTIONS

(71) Applicant: Bose Corporation, Framingham, MA (US)

(72) Inventor: Mark A. Pircaro, Yuma, AZ (US)

(21) Appl. No.: 14/253,075

(22) Filed: Apr. 15, 2014

(51) Int. Cl. H04R 9/02; H04R 7/00; H04R 3/00

(52) U.S. Cl. CPC H04R 9/027; H04R 3/00; H04R 7/00

(57) ABSTRACT

A loudspeaker comprises a first acoustically radiating moving-coil transducer and a second acoustically radiating moving-coil transducer. Each transducer is actively driven by an electrical input signal. The first and second transducers are substantially coaxial and at least part of the second transducer is positioned within a central gap of the first transducer such that the voice-coil assemblies of the two transducers are arranged concentrically and are separated by an annular gap. The gap is substantially sealed by a compliant coupling means such that the two transducers move substantially in unison when the loudspeaker reproduces an input signal that has a frequency below a certain threshold value, but move substantially independently when the loudspeaker reproduces an input signal that has a frequency above the threshold.

### BACKGROUND

This disclosure relates generally to electro-acoustic transducers, including loudspeakers, and specifically to transducers that comprise distinct low-frequency and high-frequency sections.

### SUMMARY

All examples and features mentioned below can be combined in any technically possible way.

Disclosed is a compound loudspeaker apparatus that, in one aspect, includes: a first electro-acoustic transducer that comprises a first movable diaphragm connected to a first movable voice-coil assembly, wherein a first initiating motion of the first voice-coil assembly produces a first corresponding motion of the first diaphragm; a second electro-acoustic transducer that comprises a second movable diaphragm connected to a second movable voice-coil assembly, wherein a second initiating motion of the second voice-coil assembly produces a second corresponding motion of the second diaphragm, and wherein the first voice-coil assembly and the second voice-coil assembly are disposed in a first annular gap; a second annular gap between the first voice-coil assembly and the second voice-coil assembly, wherein a first end of the second annular gap separates the first diaphragm from the second diaphragm; and a coupling mechanism that compliantly bonds the first diaphragm to the second diaphragm by substantially sealing the first end of the second annular gap.

Examples may include one of the following features, or any combination thereof.

The first diaphragm comprises a central opening, and an outer diameter of the second diaphragm is smaller than an inner diameter of the central opening.

An outer diameter of the second voice-coil assembly is smaller than an inner diameter of the first voice-coil assembly.

A support structure supports the first transducer and the second transducer such that the first transducer and the second transducer are substantially coaxial, and the first voice-coil assembly and the second voice-coil assembly are substantially coaxial.

The second diaphragm is substantially positioned within the central opening of the first diaphragm, and at least part of the second voice-coil assembly is positioned concentrically within the first voice-coil assembly.

The coupling mechanism allows the second diaphragm to move substantially independently of the first diaphragm when the loudspeaker reproduces a first sound wave characterized by a first frequency above a crossover frequency of the loudspeaker, and wherein the coupling mechanism constrains the second diaphragm to move substantially in unison with the first diaphragm when the loudspeaker reproduces a second sound wave characterized by a second frequency below the crossover frequency of the loudspeaker.

The coupling mechanism is characterized by a compliance that does not substantially vary within a normal operation of the loudspeaker.

The compliant coupling comprises a compliant adhesive.

The first voice-coil assembly comprises a first annular voice coil wound around a first annular bobbin, and wherein the second voice-coil assembly comprises a second annular voice coil wound around a second annular bobbin.

A second end of the second annular gap separates the first bobbin from the second bobbin.

At least part of the first voice coil lies axially between the first end and the second end, and at least part of the second voice coil lies axially between the first end and the second end.

The coupling mechanism bonds the first voice-coil assembly to the second voice-coil assembly by substantially sealing the second end.

Substantially sealing the second end creates an airtight volume between the first voice-coil assembly and the second voice-coil assembly.

The first voice coil and the second voice coil are configured as parallel components of an electrical circuit, and wherein the first voice coil and the second voice coil are each actively driven by a respective amplified electrical signal.

The first voice coil and the second voice coil are both driven by a first output signal of a first audio amplifier.

The electrical circuit further comprises a high-pass filter configured between the output of the first audio amplifier and the second voice coil.

The first voice coil is driven by a first output signal of a first audio amplifier and the second voice coil is driven by a second output signal of a second audio amplifier.

The first output signal is processed by a first signal-processing module and the second output signal is processed by a second signal-processing module.

In another aspect, an apparatus includes a multiple voice-coil loudspeaker-driving mechanism, including: a first movable voice-coil assembly and a second movable voice-coil assembly, wherein an inner diameter of the first voice-coil assembly is larger than an outer diameter of the second voice-coil assembly; a support structure that supports the first voice-coil assembly and the second voice-coil assembly such that the first voice-coil assembly and the second voice-coil assembly are substantially coaxial, such that at least part of the second voice-coil assembly is positioned concentrically within the first voice-coil assembly, and such that an annular gap between the first voice-coil assembly and the second voice-coil assembly has a first open end and a second open end; and a coupling mechanism that compliantly bonds the first voice-coil assembly to the second voice-coil assembly by substantially sealing the first open end.

Examples may include one of the following features, or any combination thereof.

The coupling mechanism allows the second voice-coil assembly to move substantially independently of the first voice-coil assembly when the driving mechanism receives an electrical signal characterized by a first frequency above a crossover frequency of the loudspeaker, and the coupling mechanism constrains the second voice-coil assembly to move substantially in unison with the first voice-coil assembly when the driving mechanism receives an electrical signal characterized by a second frequency below the crossover frequency of the loudspeaker.

The coupling mechanism is characterized by a compliance that does not substantially vary within a normal operation of the driving mechanism.

The first voice-coil assembly comprises a first voice coil wound around a first bobbin, wherein the second voice-coil assembly comprises a second voice coil wound around a second bobbin, and wherein the annular gap separates the inner surface of the first bobbin from the outer surface of the second bobbin such that the first voice coil and the second voice coil both substantially lie within the annular gap in the axial dimension.

The first voice coil and the second voice coil are configured as parallel components of an electrical circuit, and wherein the first voice coil and the second voice coil are each actively driven by a respective amplified electrical signal.

In another aspect, an apparatus includes a loudspeaker voice-coil coupling mechanism, comprising a compliant bonding mechanism that compliantly bonds a first movable voice coil to a second voice movable coil such that: the second voice coil is substantially free to move independently of the first voice coil when receiving an electrical signal characterized by a first frequency above a crossover frequency of the loudspeaker, and the second voice coil is constrained to move substantially in unison with the first voice coil when receiving an electrical signal characterized by a second frequency below the crossover frequency of the loudspeaker.

Examples may include one of the following features, or any combination thereof.

The first voice coil and the second voice coil are configured as parallel components of an electrical circuit, and wherein the first voice coil and the second voice coil are each actively driven by a respective amplified electrical signal.

The first voice coil and the second voice coil are separated by a gap, and wherein the bonding mechanism compliantly bonds the first voice coil to the second voice coil by creating a substantially airtight seal between the first voice coil and the second voice coil.

The above and further features and advantages may be better understood by referring to the following description in conjunction with the accompanying drawings, in which like numerals indicate like structural elements and features. The drawings are not necessarily to scale and are instead primarily intended to illustrate principles of features and implementations.

Other aspects and features and combinations of them can be expressed as methods, apparatuses, systems, program products, means for performing functions, and in other ways.

### BRIEF DESCRIPTION OF THE DRAWINGS

FIG. 1 is a cross-sectional view of an example of a loudspeaker that comprises examples of compliantly coupled, actively driven, low-frequency and high-frequency sections.

FIG. 2 is a front view of the example loudspeaker of FIG. 1.

FIG. 3 shows a detail of FIG. 1's cross-sectional view of an example loudspeaker, magnified to better illustrate relationships among features of FIG. 1.

FIG. 4 illustrates an example of an electrical diagram for using a single audio amplifier to provide an input signal to the loudspeaker of FIGS. 1-3.

FIG. 5 illustrates an example of an electrical diagram for using two audio amplifiers to provide an input signal to the loudspeaker of FIGS. 1-3.

### DETAILED DESCRIPTION

This document describes examples of a loudspeaker that comprises two or more distinct sections, each of which may be actively driven by an amplified electrical signal and all of which may be coupled by a compliant coupling mechanism that provides substantially constant compliance and substantially constant stiffness throughout the audible frequency range.

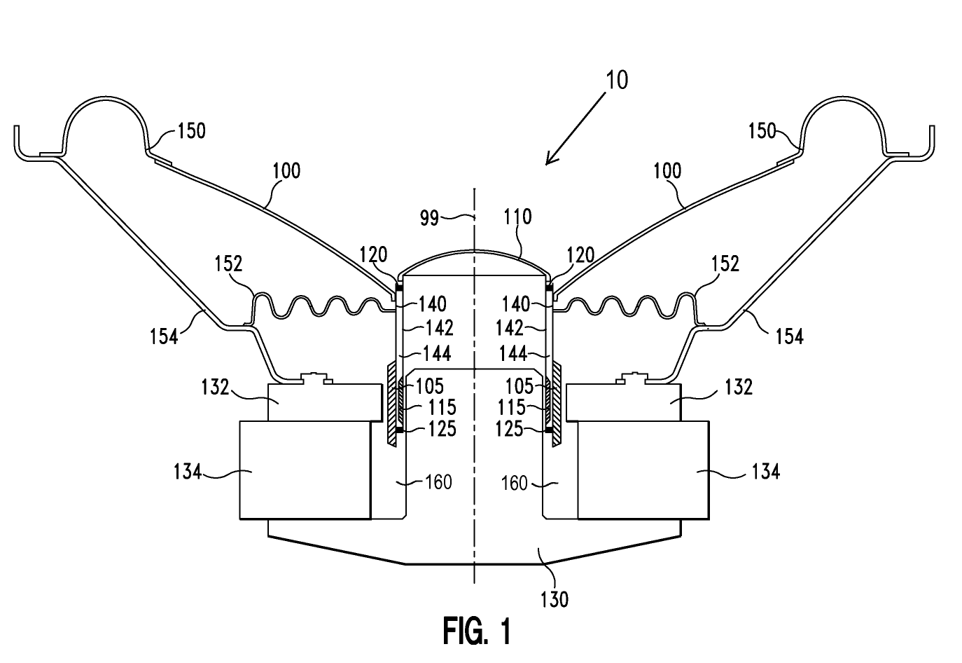

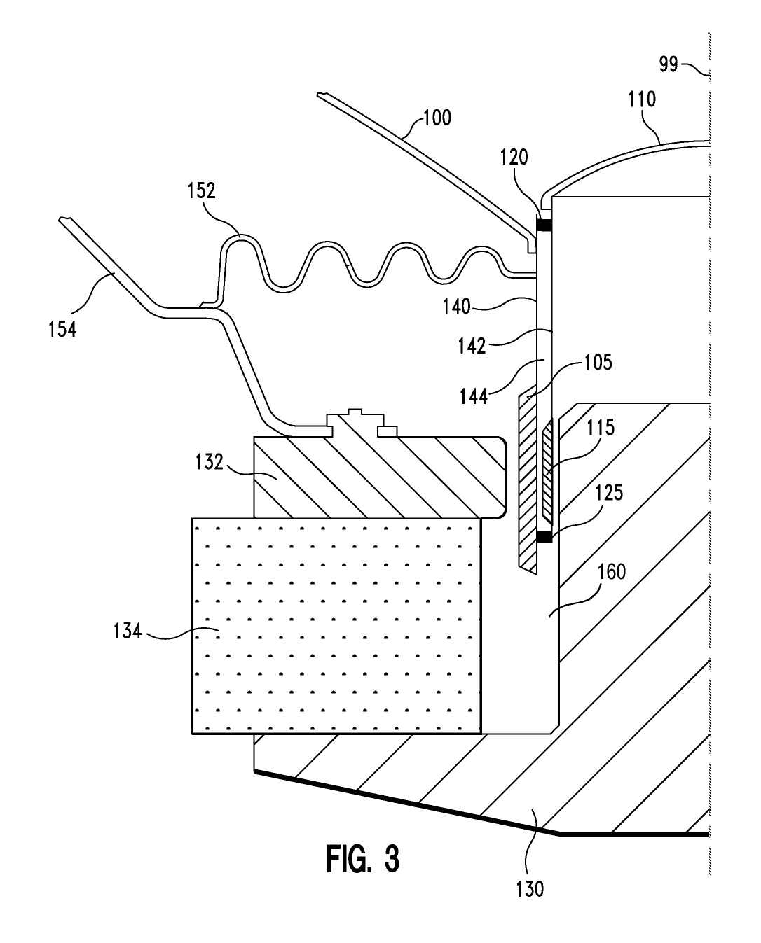

FIG. 1 is a cross-sectional view of an example of a loudspeaker 10 that comprises examples of compliantly coupled, actively driven, low-frequency and high-frequency sections. In examples herein, this loudspeaker may generate sound waves within the range of human hearing, e.g., 20 Hz to 20,000 Hz. A magnified detail of FIG. 1 is shown in FIG. 3.

Although this document describes loudspeakers comprising “low-frequency” and “high-frequency” sections, this terminology should not be construed to limit the scope of this subject matter. In other examples, features described herein may be extended to loudspeakers that comprise more than two sections, sections that reproduce overlapping frequency ranges, or sections that have other relationships in the frequency domain.

As shown in FIG. 1, an example of the low-frequency section may comprise a low-frequency diaphragm 100 affixed to a low-frequency voice-coil assembly. The low-frequency voice-coil assembly may comprise a movable low-frequency voice coil 105 that may be wound on a movable low-frequency bobbin 140. In the example of FIG. 1, low-frequency bobbin 140 is a hollow, open-ended cylinder and low-frequency voice coil 105 is a conductive strand wound around all or part of the outer surface of the low-frequency bobbin 140.

An example of the high-frequency section may comprise a high-frequency diaphragm 110 affixed to a high-frequency voice-coil assembly, wherein the high-frequency voice-coil assembly may comprise a movable high-frequency voice coil 115 that may be wound on a movable high-frequency bobbin 142. In the example of FIG. 1, the high-frequency bobbin 142 is a hollow, open-ended cylinder and the high-frequency voice coil 115 is a conductive strand wound around all or part of the outer surface of the high-frequency bobbin 142.

Examples of the transducer may further comprise magnetic and support-structure components of a type known to those skilled in the art of loudspeaker design. Some or all of these components may comprise: a pole piece and backplate assembly 130, an annular front plate 132, an annular fixed magnet 134, a flexible surround membrane 150, a flexible spider assembly (also known as a damper) 152, and a rigid or semi-rigid frame 154.

In the example of FIG. 1, this support structure supports components of the low-frequency and high-frequency sections such that the low-frequency diaphragm 100, the low-frequency voice-coil assembly (including low-frequency voice coil 105 and low-frequency bobbin 140), the high-frequency diaphragm 110, the high-frequency voice-coil assembly (including high-frequency voice coil 115 and high-frequency bobbin 142), and the fixed magnet 134, as well as the support-structure components 150-154 themselves, are substantially coaxial about a common axis 99. In FIG. 1, axis 99 lies within the plane of the page and passes axially approximately through the center points of components 100-142 and 150-154.

In operation, an electrical current produced from an electrical signal flows through voice coils 105, 115. When the electrical current in the voice coils changes direction, the magnetic forces between the voice coils and the fixed magnet 134 also change, causing the voice coils to move up and down. This up-and-down movement of the voice coils translates to movement of the diaphragms 100, 110. This movement of the diaphragms causes changes in air pressure, which results in production of sound. In such a transducer, the high-frequency and low-frequency sections are free to vibrate or move within respective distinct ranges of motion parallel to axis 99 and thus radiate sound in dispersion patterns that are functions of axis 99.

In the example of FIG. 1, an inner diameter of a central opening of low-frequency diaphragm 100 is larger than an outer diameter of high-frequency diaphragm 110, allowing diaphragm 110 to be positioned concentrically within diaphragm 100. Similarly, an inner diameter of low-frequency voice-coil assembly 105 and 140 is shown to be larger than an outer diameter of high-frequency voice-coil assembly 115 and 142 such that the high-frequency assembly 115 and 142 may fit concentrically within low-frequency assembly 105 and 140. In other examples, these geometric relationships may vary. In some implementations, for example, an inner diameter of the central opening may be smaller than an outer diameter of high-frequency diaphragm 110. In such a case, a lip or outer edge of the high-frequency diaphragm 110 might overlap the inner edge of the low-frequency diaphragm 100. Such an overlap might provide greater strength, durability, or stiffness to the seal between the high-frequency diaphragm 110 and lower-frequency diaphragm 100 by providing a greater surface area to be sealed or by increasing an efficiency of the high-frequency diaphragm 110 by increasing the radiating surface area of the high-frequency diaphragm 110.

In other examples not shown here, one or more components of the loudspeaker may not be coaxial and two or more diaphragms of the loudspeaker may not move, or radiate sound, substantially in parallel with a common axis. Two or more diaphragms may, for example, be positioned side-by-side, rather than concentrically, or may point in different directions. In an implementation wherein diaphragms are, for example, semicircular, a straight edge of a low-frequency diaphragm may be positioned adjacent to straight edges of two or more midrange- or high-frequency diaphragms. In other examples, a low-frequency section and a high-frequency section may move along different axes or may be parallel to a common axis, but point in opposite directions.

FIG. 1 shows the low-frequency diaphragm 100 as a cone with a central opening and shows the high-frequency diaphragm 110 as a dome partially protruding through the central opening. But in other implementations, either diaphragm may assume another shape, such as a NAWI surface (having a cross-section defined by an exponential or hyperbolic curve); a flat plane with a semicircular, circular, rectangular, elliptical, or other-shaped perimeter; a surface with a ridged perimeter; a hemisphere or dome; a cone; an open or closed cylinder, tube, or cigar-like shape; or any other shape that may allow a diaphragm to move air when driven by a mechanism similar to those described herein.

As described above, the two diaphragms 100 and 110 may each be attached to a respective voice-coil assembly such that each diaphragm/voice-coil assembly pair moves substantially as a unit in response to an electrical audio signal, in accordance with technologies and methods known to those skilled in a the art of speaker design.

The low-frequency diaphragm 100 and low-frequency bobbin 140 thus may move along axis 99 in response to motions of low-frequency voice-coil 105 along axis 99, and the high-frequency diaphragm 110 and high-frequency bobbin 142 thus may move along axis 99 in response to motions of high-frequency coil 115 along axis 99.

Examples of the low-frequency voice coil 105 may comprise one or more electrically conductive strands and may move in parallel with axis 99 in in response to variable force on the voice coil 105 that may be created by an interaction between a fixed magnetic field of magnet 134 and a first variable electric current (such as a first electrical audio signal) when the variable electric current passes through the voice coil 105.

Similarly, examples of the high-frequency voice coil 115 may comprise one or more electrically conductive strands and may move in parallel with axis 99 in response to variable force on the voice coil 115 that may be created by an interaction between a fixed magnetic field of magnet 134 and a second variable electric current (such as a second electrical audio signal) when the variable electric current passes through the voice coil 115

The support mechanism may further support the annular magnet 134 and the annular front plate 132, such that the fixed magnetic field of magnet 134 interacts with variable magnetic fields induced by electric current passing through voice coil 105 or 115. The front plate 132 may further axially stiffen or strengthen the support mechanism and may itself become magnetized due to its proximity to magnet 134, thus extending the range, or otherwise altering characteristics, of the fixed magnetic field.

In a loudspeaker wherein components of the loudspeaker are positioned coaxially, as shown in FIG. 1, a first annular gap 160 may exist between pole piece 130 and front plate 132 and magnet 134. In such cases, the pole piece 130, the high-frequency voice coil 115, the low-frequency voice coil 105, and the front plate 132/magnet 134 might be arranged substantially concentrically about common axis 99 within the first annular gap 160.

Examples of the support mechanism may position the voice-coil assemblies to further create a second annular gap 144 between low-frequency voice-coil assembly 105 and 140 and high-frequency voice-coil assembly 115 and 142. In the example of FIG. 1, this second annular gap 144 may extend along an axial dimension (parallel to axis 99) from an annular top opening 120 between high-frequency diaphragm 110 and low-frequency diaphragm 100 down to an annular bottom opening 125 below a bottom edge of high-frequency voice-coil 115.

The second annular gap 144 may be substantially sealed at the top opening 120 by a compliant coupling mechanism, such as a first annular bead of adhesive, several beads or dots of adhesive, an annular washer attached by one or more beads of adhesive, another springlike mechanism, or another suspension mechanism, and may optionally be substantially sealed at the bottom opening 125 by a second bead or dot of adhesive (or multiple beads or dots of adhesive). If both openings are sealed, the annular gap may become substantially airtight and may contain a sealed vacuum or a sealed volume of a gas other than air. Examples of the coupling mechanism may exhibit compliance that does not substantially vary as a function of relative motion of the coupled entities, as a function of a frequency of an audio signal reproduced by the loudspeaker, or throughout an operating temperature range of the loudspeaker. Suitable adhesives may comprise, but are not limited to, silicones, polyurethanes, and types of elastomeric substances.

Because the coupling mechanism's compliance (or inverse of its stiffness) may be constant throughout a useful temperature range, examples of the coupling mechanism may behave like a damped spring in compliance with Hooke's Law and with other principles of elasticity and damped harmonic oscillation known to those skilled in the art. Therefore, when examples of the loudspeaker reproduce lower-frequency waveforms, the coupled voice-coil assemblies and coupled diaphragms tend to move in unison, but when examples of the loudspeaker reproduce higher-frequency waveforms, the voice coils and diaphragms tend to move independently.

In some examples, a crossover frequency of the loudspeaker will identify a transition range between a first range of higher-frequency input signals, at which the higher-frequency diaphragm 110 will move substantially independently of the lower-frequency diaphragm 100, and a second range of lower-frequency input signals, at which the higher-frequency diaphragm 110 will move substantially in unison with the lower-frequency diaphragm 100.

In the example of FIG. 1, the coupling at top opening 120 substantially seals and compliantly couples low-frequency diaphragm 100 to high-frequency diaphragm 110, substantially preventing air leakage between the two drivers. In other examples, wherein a component or gap may assume a different shape or organization, an analogous coupling may perform a function similar to the example of compliant coupling depicted in FIG. 1. If, for example, a loudspeaker comprises a pair of adjacent rectangular diaphragms, a linear bead or a linear set of dots of adhesive might bond and couple the two diaphragms along a common straight-edge boundary.

Technical features of this design, including the compliant coupling and the multiple actively driven voice coils, may provide one or more advantages.

In a compound loudspeaker wherein smaller and larger diaphragms are substantially concentric, the larger diaphragm may constrain the acoustic radiation of the smaller diaphragm by acting as a horn or waveguide. If there is substantial relative motion between the two diaphragms when the compound loudspeaker reproduces lower frequencies, the waveguide-like characteristics of the lower-frequency diaphragm vary as a function of changes in the relative positions of the diaphragms. As would be the case when a transducer is loaded by a variable-position horn, this effect modulates the acoustic radiation impedance seen by the higher-frequency diaphragm, thereby modulating an efficiency of the higher-frequency diaphragm and dispersion characteristics of the higher-frequency diaphragm. The acoustic pressure generated by the higher-frequency section would thus be modulated by variations in the excursion of the lower-frequency driver, thereby producing undesired intermodulation distortion.

But in loudspeaker systems like those of FIG. 1, wherein a high-frequency diaphragm remains in a substantially stable position axially relative to a position of a coaxial or concentrically located low-frequency diaphragm, despite movement of the low-frequency diaphragm, this undesirable frequency-dependent modulation of the high-frequency driver's radiation pattern and efficiency characteristics may be reduced or eliminated.

Another advantage may be to improve an efficiency of a lower-frequency section of the loudspeaker. If a portion of a larger diaphragm is removed to make room for a second smaller diaphragm, then the volume of air moved by the larger diaphragm at a particular excursion is reduced in proportion to the effective radiating area of the removed portion. But in designs similar to those depicted in FIG. 1, the smaller diaphragm substantially restores the lost radiating area by duplicating the motion of the lost portion.

Other advantages of this design arise from the optional feature of substantially sealing a gap between the two diaphragms of the loudspeaker. Without such a seal, undesirable air leakage between the diaphragms may reduce low-frequency output when the loudspeaker is mounted in a cabinet. This effect may be reduced if the leakage path is relatively long and narrow, but designs similar to those depicted in FIG. 1 would substantially eliminate such leakage. In addition to improving efficiency, such sealing may also prevent debris from accumulating behind the diaphragms or near the voice coil assemblies, and prevent whistling and other pipe-like and noise-like artifacts associated with turbulent air flows.

Yet another advantage of this design may be improved efficiency or flexibility as a result of actively driving all compliantly coupled voice coils. Unlike designs that transmit a signal to one coil and allow the second coil to be driven passively by a force generated by a mutual inductance between the two coils, examples of the present design can allow each coil to receive a distinct signal tailored for physical or electrical characteristics of components that reproduce the signal. Such tailoring may comprise splitting the signal into sub-signals that pass through an active or passive high-pass, low-pass, or band-pass filter, an amplifier or attenuator, an equalizer, or a more complex analog or digital signal processing functions. Such signal-tailoring may be utilized to ensure acceptable performance of a loudspeaker subject to design constraints of a compound-transducer design.

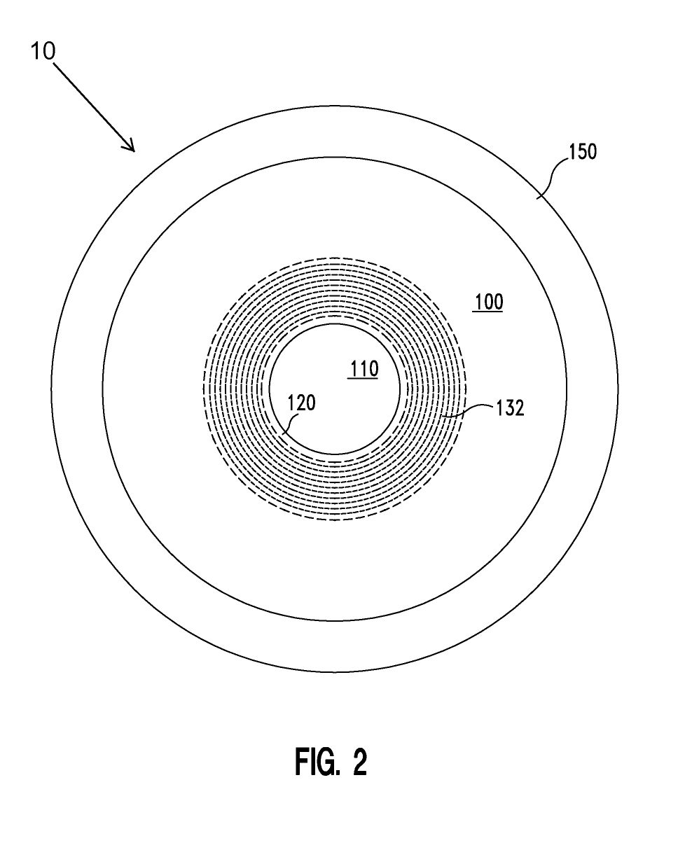

FIG. 2 is a front view of the example loudspeaker 10 of FIG. 1. Here, as in FIG. 1, a low-frequency diaphragm 100 is suspended by a flexible surround membrane 150 that allows the diaphragm 100 to move or vibrate within a restricted range of motion substantially perpendicular to the plane of FIG. 2. Axis 99 of FIG. 1 is not shown in FIG. 2, but is perpendicular to the plane and passes approximately through the center points of items 100-132 of FIG. 2. High-frequency diaphragm 110 may be coaxially located with respect to low-frequency diaphragm 100 and the two may be separated by an annular opening 120. Front plate 132, shown here with shading and a dotted outline, may be positioned behind diaphragm 100 and is not visible from the front of the loudspeaker. Features shown in FIG. 1 that lay behind plate 132 are omitted.

FIG. 3 shows a detail of FIG. 1's cross-sectional view of example loudspeaker 10, magnified to better illustrate relationships among features of FIG. 1. Here, as in FIG. 1, high-frequency diaphragm 110 may be mounted coaxially and concentrically within a central opening of low-frequency diaphragm 100. The high-frequency diaphragm 110 may be attached to high-frequency bobbin 142 around which a high-frequency voice coil 115 may be wound, and the low-frequency diaphragm 100 may be similarly attached to a low-frequency bobbin 140 around which a low-frequency voice coil 105 may be wound. In this example, the high-frequency diaphragm 110, bobbin 142, and voice coil 115 are each respectively smaller in diameter than the low-frequency diaphragm 100, bobbin 140, and voice coil 105.

Moving bobbins 140 and 142 and their respective voice coils 105 and 115 may be separated by second annular gap 144, which may be substantially sealed at the top by a compliant coupling mechanism 120, such as a bead or dots of adhesive that bonds diaphragms 100 and 110. The coupling mechanism may optionally similarly bond or otherwise connect high-frequency bobbin 142 and coil 115 to low-frequency bobbin 140 and coil 105 at the opposite end of gap 142.

Here, a motion of diaphragm 100 or 110 may be further constrained by support-structure components 130 and 150-154 to move substantially only in parallel with axis 99. As in FIG. 1, the voice-coil assemblies are encircled by a front plate 132 and fixed magnet 134. In other examples, an arrangement of some or all components shown in FIGS. 1-3 may differ.

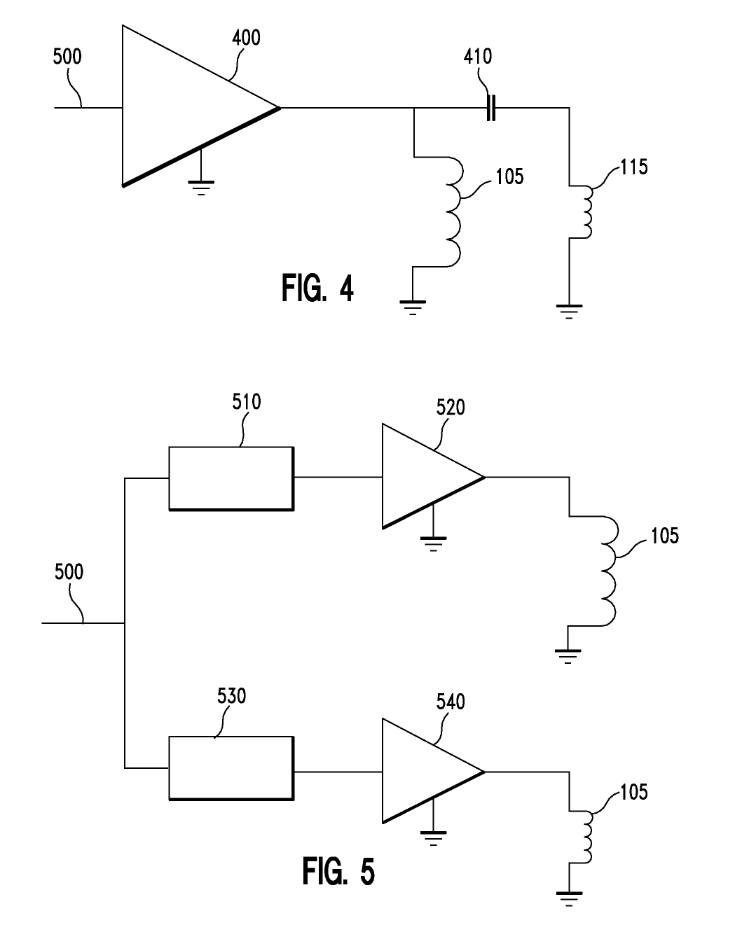

FIG. 4 illustrates an example of an electrical diagram for using a single audio amplifier to provide an input signal to the loudspeaker of FIGS. 1-3. Here, input signal 500 is amplified by audio amplifier 400 to produce a variable electric current that passes through low-frequency voice coil 105 and high-frequency voice coil 115. This variable current induces variable magnetic fields around the two voice coils 105 and 115 that interact with the fixed magnetic field of magnet 134, resulting in a variable force on each voice coil. These variable forces move the voice coils along their axis of motion (parallel to axis 99), in turn moving respective bobbins 140 and 142 and respective diaphragms 100 and 110.

In this single-amplifier configuration, voice coils 105 and 115 are connected in parallel between the amplifier output and circuit ground. The electric current passing through the coils may be further processed by a high-pass filter 410 configured in series between the amplifier's output and high-frequency voice coil 115. This high-pass filter 410 allows only higher-frequency components of the input signal to reach the higher-frequency voice coil 115 by creating a filter circuit that may comprise one or both of the voice coils.

FIG. 4 shows the high-pass filter 410 as a single capacitor. In other examples, high-pass filter 410 may comprise a more complex active or passive circuit and may include additional amplification or multi-stage filtering functions, based on techniques and technologies known to those skilled in the art.

The circuit of FIG. 4 may be configured so as to amplify an audio input signal, split the amplified signal into higher-frequency and lower-frequency bands, and drive each voice coil with input frequencies selected to optimize performance of the loudspeaker.

FIG. 5 illustrates an example of an electrical diagram for using two audio amplifiers to provide an input signal to the loudspeaker of FIGS. 1-3. In other examples, wherein examples of the loudspeaker comprise more than two transducers, equivalent circuits may comprise more than two amplifiers and more than two signal-processing modules.

In this configuration, input signal 500 is split into two signals, one of which passes through a low-frequency signal processor 510 that may filter the input signal 500 to limit its frequency bandwidth, apply single-band or multiband equalization, or perform other processing functions necessary to optimize the signal for reproduction by the low-frequency diaphragm 100. This processed output is then amplified by low-frequency audio amplifier 520 to produce a variable electric current that passes through low-frequency voice coil 105 to drive the low-frequency diaphragm 100.

Similarly, the other portion of input signal 500 passes through a high-frequency signal processor 530 that may filter the input signal 500 to limit its bandwidth, apply single-band or multiband equalization, or perform other processing functions necessary to optimize the signal for reproduction by the high-frequency diaphragm 110. This processed output is then amplified by a high-frequency audio amplifier 540 to produce a variable electric current that will pass through the high-frequency voice coil 115 to drive the high-frequency diaphragm 110.

In other examples, the low-frequency signal processor 510 may be configured solely at the output, rather than solely at the input, of the low-frequency amplifier 520, or at both the input and the output, and the high-frequency signal processor 530 may be configured solely at the output, rather than solely at the input, or at both the input and the output, of the high-frequency amplifier 540. Furthermore, in some examples, the low-frequency signal processor 510 or the high-frequency signal processor 530 may comprise a passive circuit, such as a capacitor or a passive RC or RLC filter. In other cases, processor 510 or 530 may comprise a more complex active filtering or digital signal-processing circuit, as taught by technologies and techniques known to those skilled in the art of circuit design.

The circuit of FIG. 5 may be configured so as to split an input signal into multiple signals that are each amplified and optimized for reproduction by a specific section of a loudspeaker.

The foregoing descriptions and figures are intended to illustrate and not to limit the scope of subject matter defined by the claims. Accordingly, it will be understood that additional modifications may be made without departing from the scope of the inventive concepts described herein and that other examples fall within the scope of the following claims.

What is claimed is:

1. A loudspeaker, comprising:
a first electro-acoustic transducer that comprises a first movable diaphragm connected to a first movable voice-coil assembly, wherein a first initiating motion of the first voice-coil assembly produces a first corresponding motion of the first diaphragm;
a second electro-acoustic transducer that comprises a second movable diaphragm connected to a second movable voice-coil assembly, wherein a second initiating motion of the second voice-coil assembly produces a second corresponding motion of the second diaphragm, and wherein the first voice-coil assembly and the second voice-coil assembly are disposed in a first annular gap;
a second annular gap between the first voice-coil assembly and the second voice-coil assembly, wherein a first end of the second annular gap separates the first diaphragm from the second diaphragm; and
a coupling mechanism that compliantly bonds the first diaphragm to the second diaphragm by substantially sealing the first end of the second annular gap.

2. The loudspeaker of claim 1, wherein the first diaphragm comprises a central opening, and an outer diameter of the second diaphragm is smaller than an inner diameter of the central opening.

3. The loudspeaker of claim 1, wherein an outer diameter of the second voice-coil assembly is smaller than an inner diameter of the first voice-coil assembly.

4. The loudspeaker of claim 1, further comprising a support structure that supports the first transducer and the second transducer such that the first transducer and the second transducer are substantially coaxial, and the first voice-coil assembly and the second voice-coil assembly are substantially coaxial.

5. The loudspeaker of claim 2, wherein the second diaphragm is substantially positioned within the central opening of the first diaphragm, and at least part of the second voice-coil assembly is positioned concentrically within the first voice-coil assembly.

6. The loudspeaker of claim 1,
wherein the coupling mechanism allows the second diaphragm to move substantially independently of the first diaphragm when the loudspeaker reproduces a first sound wave characterized by a first frequency above a crossover frequency of the loudspeaker, and
wherein the coupling mechanism constrains the second diaphragm to move substantially in unison with the first diaphragm when the loudspeaker reproduces a second sound wave characterized by a second frequency below the crossover frequency of the loudspeaker.

7. The loudspeaker of claim 1,
wherein the coupling mechanism is characterized by a compliance that does not substantially vary within a normal operation of the loudspeaker.

8. The loudspeaker of claim 1, wherein the coupling mechanism comprises a compliant adhesive.

9. The loudspeaker of claim 1, wherein the first voice-coil assembly comprises a first annular voice coil wound around a first annular bobbin, and wherein the second voice-coil assembly comprises a second annular voice coil wound around a second annular bobbin.

10. The loudspeaker of claim 9, wherein a second end of the second annular gap separates the first bobbin from the second bobbin.

11. The loudspeaker of claim 10, wherein at least part of the first voice coil lies axially between the first end and the second end, and at least part of the second voice coil lies axially between the first end and the second end.

12. The loudspeaker of claim 11, wherein the coupling mechanism bonds the first voice-coil assembly to the second voice-coil assembly by substantially sealing the second end.

13. The loudspeaker of claim 12, wherein substantially sealing the second end creates an airtight volume between the first voice-coil assembly and the second voice-coil assembly.

14. The loudspeaker of claim 9, wherein the first voice coil and the second voice coil are configured as parallel components of an electrical circuit, and wherein the first voice coil and the second voice coil are each actively driven by a respective amplified electrical signal.

15. The loudspeaker of claim 14, wherein the first voice coil and the second voice coil are both driven by a first output signal of a first audio amplifier.

16. The loudspeaker of claim 15, wherein the electrical circuit further comprises a high-pass filter configured between the output of the first audio amplifier and the second voice coil.

17. The loudspeaker of claim 14, wherein the first voice coil is driven by a first output signal of a first audio amplifier and the second voice coil is driven by a second output signal of a second audio amplifier.

18. The loudspeaker of claim 17, wherein the first output signal is processed by a first signal-processing module and the second output signal is processed by a second signal-processing module.

19. A multiple voice-coil loudspeaker-driving mechanism, comprising:
a first movable voice-coil assembly and a second movable voice-coil assembly, wherein an inner diameter of the first voice-coil assembly is larger than an outer diameter of the second voice-coil assembly;
a support structure that supports the first voice-coil assembly and the second voice-coil assembly such that the first voice-coil assembly and the second voice-coil assembly are substantially coaxial, such that at least part of the second voice-coil assembly is positioned concentrically within the first voice-coil assembly, and such that an annular gap between the first voice-coil assembly and the second voice-coil assembly has a first open end and a second open end; and
a coupling mechanism that compliantly bonds the first voice-coil assembly to the second voice-coil assembly by substantially sealing the first open end.

20. The loudspeaker-driving mechanism of claim 19,
wherein the coupling mechanism allows the second voice-coil assembly to move substantially independently of the first voice-coil assembly when the driving mechanism receives an electrical signal characterized by a first frequency above a crossover frequency of the loudspeaker, and
wherein the coupling mechanism constrains the second voice-coil assembly to move substantially in unison with the first voice-coil assembly when the driving mechanism receives an electrical signal characterized by a second frequency below the crossover frequency of the loudspeaker.

21. The loudspeaker-driving mechanism of claim 19,
wherein the coupling mechanism is characterized by a compliance that does not substantially vary within a normal operation of the driving mechanism,

22. The loudspeaker-driving mechanism of claim 19, wherein the first voice-coil assembly comprises a first voice coil wound around a first bobbin, wherein the second voice-coil assembly comprises a second voice coil wound around a second bobbin, and wherein the annular gap separates the inner surface of the first bobbin from the outer surface of the second bobbin such that the first voice coil and the second voice coil both substantially lie within the annular gap in the axial dimension.

23. The loudspeaker-driving mechanism of claim 21, wherein the first voice coil and the second voice coil are configured as parallel components of an electrical circuit, and wherein the first voice coil and the second voice coil are each actively driven by a respective amplified electrical signal.

24. A loudspeaker voice-coil coupling mechanism, comprising a compliant bonding mechanism that compliantly bonds a first movable voice coil to a second voice movable coil such that: the second voice coil is substantially free to move independently of the first voice coil when receiving an electrical signal characterized by a first frequency above a crossover frequency of the loudspeaker, and the second voice coil is constrained to move substantially in unison with the first voice coil when receiving an electrical signal characterized by a second frequency below the crossover frequency of the loudspeaker.

25. The voice-coil coupling mechanism of claim 24, wherein the first voice coil and the second voice coil are configured as parallel components of an electrical circuit, and wherein the first voice coil and the second voice coil are each actively driven by a respective amplified electrical signal.

26. The voice-coil coupling mechanism of claim 24, wherein the first voice coil and the second voice coil are separated by a gap, and wherein the bonding mechanism compliantly bonds the first voice coil to the second voice coil by creating a substantially airtight seal between the first voice coil and the second voice coil.
